(19) United States
(12) Patent Application Publication
(10) Pub. No.: US 2005/0283441 A1
(43) Pub. Date: Dec. 22, 2005

(54) Efficient policy change management in virtual private networks

(75) Inventors: Yashodhan Deshpande, San Jose, CA (US); Naveen Kulshreshtha, Fremont, CA (US); Manohar Mahavadi, Fremont, CA (US)

Correspondence Address: David B. Ritchie;THELEN REID & PRIEST LLP, P.O. BOX 640640, SAN JOSE, CA, 95164-0640, US

(73) Assignee: IPolicy Networks, Inc., a Delaware corporation

(21) Appl. No.: 10/873,754

(22) Filed: Jun. 21, 2004

(51) Int. Cl. G06Q 99/00

(52) U.S. Cl. 705/64

(57) ABSTRACT

A solution is provided wherein the granularity of traffic disruption is on a per rule basis rather than a per customer basis. In an embodiment of the present invention, this is accomplished using two banks, an active bank, which may be used to work on the live traffic flowing through the unit, and a new bank, which may be used for downloading the changed policies for further processing. Whenever any change in the policies is made and applied, the new policies get downloaded into the new bank, and each module then has a chance to work on the new bank. Once the work is complete, then a switch to the new bank may be made. This guarantees smooth transition between the old and new policies.

### FIELD OF THE INVENTION

The present invention relates to the field of computer network security. More specifically, the present invention relates to the management of policy changes in a computer network supporting Virtual Private Networks.

### BACKGROUND OF THE INVENTION

A virtual private network (VPN) is a wide area network that connects private subscribers (such as employees of the same company) together using the public Internet as a transport medium, while ensuring that their traffic is not readable by the Internet at large. All of the data is encrypted to prevent others from reading it, and authentication measures ensure that only messages from authorized VPN users can be received.

Internet Protocol Security (IPsec) is a standard for security on the Internet that is commonly used to implement VPNs. IPsec (and other VPN standards) utilizes security associations in creating VPNs. These security associations, also known as tunnels, are typically negotiated by the end nodes before traffic is secured.

A security policy in a VPN is typically implemented using a series of rules. Each rule corresponds to a particular security policy. Table 1 below illustrates examples of VPN policies. In this table, rule 1 is a simple single source single designation rule, rule 2 is an application specific rule, rule 3 is a subnet rule, and rule 4 is a remote user specific rule.

TABLE 1

| Rule- | | | | | | IPSEC |
|---|---|---|---|---|---|---|
| No | Source | Destination | Application | Direction | Action | Properties |
| 1. | 192.168.1.1 | 208.206.2.2 | Any | Any | IPSEC | Ipsec1 |
| 2. | 192.168.1.2 | 208.206.2.2 | HTTP | Any | IPSEC | Ipsec1 |
| 3. | 202.101.1/24 | 206.101.1/24 | Any | Any | IPSEC | Ipsec1 |
| 4. | UserGrp1 | HomeNet | Any | Inbound | IPSEC | Ipsec1 |

When policies that have been configured need to be changed, or when new policies have to be configured, an administrator will typically use a user interface to make changes and to apply changes to a VPN gateway. When these policies are applied, all security associations in use are renegotiated, thus all traffic related to customers using the security associations must be interrupted. This even applies to customers whose policies have not changed. This can be greatly disruptive to a system, especially in multi-customer multi-user managed services deployments. This is known as a complete disruptive download, as whenever policies are changed and applied to a working system, all existing security associations are deleted and renegotiated to establish VPN tunnels again.

One solution to this problem is known as a partial disruptive apply. Here, policies are clustered for each customer at the user interface level. Using this approach, the policy processing will be performed at the user interface level and when one customer's policies are changed, then policies related to another customer using different policies will not be affected during the apply. However, many customers share common policies. Using this approach, even though common policies may not be related to VPN, changing common policies will result in traffic disruption due to the renegotiation of security associations.

What is needed is a non-disruptive solution that breaks only those security associations whose properties have genuinely changed, while still maintaining efficiency.

### BRIEF DESCRIPTION

A solution is provided wherein the granularity of traffic disruption is on a per rule basis rather than a per customer basis. In an embodiment of the present invention, this is accomplished using two banks, an active bank, which may be used to work on the live traffic flowing through the unit, and a new bank, which may be used for downloading the changed policies for further processing. Whenever any change in the policies is made and applied, the new policies get downloaded into the new bank, and each module then has a chance to work on the new bank. Once the work is complete, then a switch to the new bank may be made. This guarantees smooth transition between the old and new policies.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a flow diagram illustrating a method for applying a change or addition to a security policy in a computer network in accordance with an embodiment of the present invention.

FIG. 2 is a block diagram illustrating an apparatus for applying a change or addition to a security policy in a computer network in accordance with an embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides a solution where the granularity of traffic disruption is on a per rule basis rather than a per customer basis. Thus, if only one property of one of the security associations of a customer has been changed, then only that tunnel traffic would get affected and all other traffic would flow as is. If any rules for other modules are added or modified, it would not affect the VPN traffic. Changing the order of the rules or inserting rules in between existing rules would also not affect the traffic.

In an embodiment of the present invention, in order to achieve the granularity mentioned above, all of the identification of changes in policies may be handled in the VPN module itself, rather than performing the task on a configuration system. Since the VPN module is aware of all the policies specific to it, it does not care about what changes are made to other modules (firewall, intrusion detection system, etc.). Thus, it becomes much easier to implement the solution at this level rather than at the user interface level as was done in the past.

In an embodiment of the present invention, there are two banks available for downloading policies. One is the active bank, which may be used to work on the live traffic flowing through the unit. The other bank is used for downloading the changed policies for further processing. Whenever any change in the policies is made and applied, the new policies get downloaded into the new bank, and each module then has a chance to work on the new bank. Once the work is complete, then a switch to the new bank may be made. This delays the application of new policies, but guarantees smooth transition between the old and new policies.

The process may be implemented in three stages. In the first stage, the policy data may be efficiently organized at the time of download. This may include creating hash tables, taking into consideration all the static parameters for any VPN policy/rule. Thus, the hash may be calculated on each VPN rule configured and entered into the hash table. In the second stage, changes in IPSEC properties may be identified, and the unchanged configuration may be restored. Here, whenever a new policy is downloaded into the new bank, then a new hash table is created for the new policy getting downloaded, but for each of the new policy rules the same hash is used to search for any matching entries in the old policy bank. If a perfect matching entry is found, it indicates that there is no change for this security association and all the dynamic data (for active Phase 1 and Phase 2) associated to this rule needs to be maintained or retained. All these may be restored in the new bank scattered across multiple tables. During this stage 2 processing, if a perfect matching hash entry is not found in the old rule bank for any rule in the new bank, then that particular rule in the new bank may be considered to be either a modified old rule or a newly created rule. In both these cases, the security associations will have to first be deleted and then reestablished by negotiating the tunnel properties.

In the third stage, the system may switch to the new configuration without any loss of data. By ensuring that the old policies are in effect and traffic continues to flow using the old policies during the apply process, traffic will not be disrupted. Once the apply process has been completed, the new tunnels may be established and the outdated tunnels may be deleted. Thus, if a new tunnel is to be established before the apply process has been completed, it may be delayed until that happens. This delay, however, is likely to be very small and have little impact on the overall functioning of the system. Once the apply process is complete, an instant transition may be made to the new bank and everything starts functioning normally again.

Referring back to the first stage, a VPN rule is typically made up of three main components. Phase 1 properties, Phase 2 properties, and selectors. Phase 1 properties define the security properties for establishing a secure channel between two gateways, which will be used for further negotiation of encryption and decryption keys. Phase 2 properties define the actual properties to be used while encrypting the data for securing the traffic between two tunnel termination points. The selectors bind these two types of properties together, and define a complete VPN policy/rule. Other properties may also be associated with the rule, such as user properties and user group properties.

Each rule can effectively have around 40 different values for phase 1 configuration, around 50 different values for phase 2 configuration, and 5-20 values for selectors based on whether it is a single IP address or range or a user base rule. Any change in any of these values would account for a change in the properties. Thus, it is practically impossible to do a one to one matching of each old rule and new rule and find a matching rule or non-matching rule.

In an embodiment of the present invention, the above rules may be inserted into two different hash tables. One hash table may take into consideration all the selector fields and phase 1 properties. This may be called the phase 1 hash table. The second hash table may take into consideration all the phase 2 properties. This may be called the phase 2 hash table. As mentioned above, each hash table on average represents 50 different values. Since the value types are miscellaneous, they could be numeric values, enumerations, strings, IP addresses, ranges, etc. Nevertheless, a simple approach may be used in calculating the hash. All the values may be considered to be a sequence of bytes/words and a simple addition of all the value may be performed, which forms a 32 bit hash key. In an embodiment of the present invention, the hash table size may be fixed to 1024, limiting the real index to the last 10 bits. However, since the values are variable, there would still be a good distribution.

Having two different hash tables helps in identifying whether phase 1 properties have changed or phase 2 properties have changed (or neither). If phase 1 properties have changed, then the system need not examine whether phase 2 properties have changed or not, since phase 2 properties depends on phase 1 properties, and thus all phase 2 properties associated with the changed phase 1 property will eventually have to be deleted.

Referring back to the second stage, the concept of banks may be used to support the non-disruptive apply process. Whenever any change is made in the configuration and applied on the new device, the new configuration does not directly overwrite the old configuration. The new configuration may be downloaded into a separate memory area. The new configuration may only come into the picture after a policy change signal is given to the system. Thus, the system has time to restore the unchanged configuration during this window.

In an embodiment of the present invention, whenever the new policy download into the new bank is complete, processing of the security policy table (SPD) may be initiated. Each SPD entry may correspond to a VPN rule. Each rule may have all the details associated to it as mentioned above. For each of the rules, the hash may be calculated as mentioned above and an entry may be inserted into the new bank hash table. A search may then be made for a matching entry in the old bank hash table. If a matching entry for a phase 1 property or selector is found, then dynamic data for the phase 1 property or selector may be added into the new bank (in an embodiment of the present invention, it may be stored in a phase 1 tree in the new bank). Once the matching of all the phase 1 properties is complete, all remaining phase 1's in the old bank may be deleted, along with their corresponding Phase 2 properties.

Next, for each of the phase 1 properties that have been matched, the system may then attempt to match phase 2 properties for those phase 1 properties. This process may be performed in a similar way to the phase 1 properties, where the new bank phase 2 hash table may be created and a corresponding entry searched in the old phase 2 data structure. If a matching entry is found, then the dynamic data for the phase 2 property may be copied from the old bank into the new bank. Additionally, since the phase 2 data often is partially stored in a data block, then somehow this information should be maintained in the new bank. Rather than copy over the entire security association data block from the old bank to the new bank, which is inefficient, a new pointer may simply be created in the new bank pointing to the old data block.

By using this restoring process, minimal searching is required and unmatched data is eliminated as early as possible. The restoring is also completed in a short time so that the end user does not see the delay in the apply process.

Referring back to the third stage, there are two main parts to switching to the new configuration without any loss of data. First is the usage of two banks, and the other is the stopping of the process of establishment and deletion of the security association during the process.

Having two banks gives the system the flexibility of acting on both the old and the new policies simultaneously. Since the new policies are downloaded into the new bank, the new bank data structures may safely be acted upon without affecting the traffic flow or data structures in the old bank.

The process of establishment and deletion of security associations may be stopped during the time span of the apply process. This way, it can be guaranteed that there will be no changes in the data structures in the old bank while the logic of non-disruptive apply is executing. Although at first glance this may appear to mean that the expirations of security associations are delayed, the tunnels are in fact expired and traffic is blocked. The only difference is that new tunnel initiations are delayed. Thus, at most, a user may see a few packet drops, which in most applications won't even be visible. This small limitation, however, guarantees the state fullness of the system with minimal disruption.

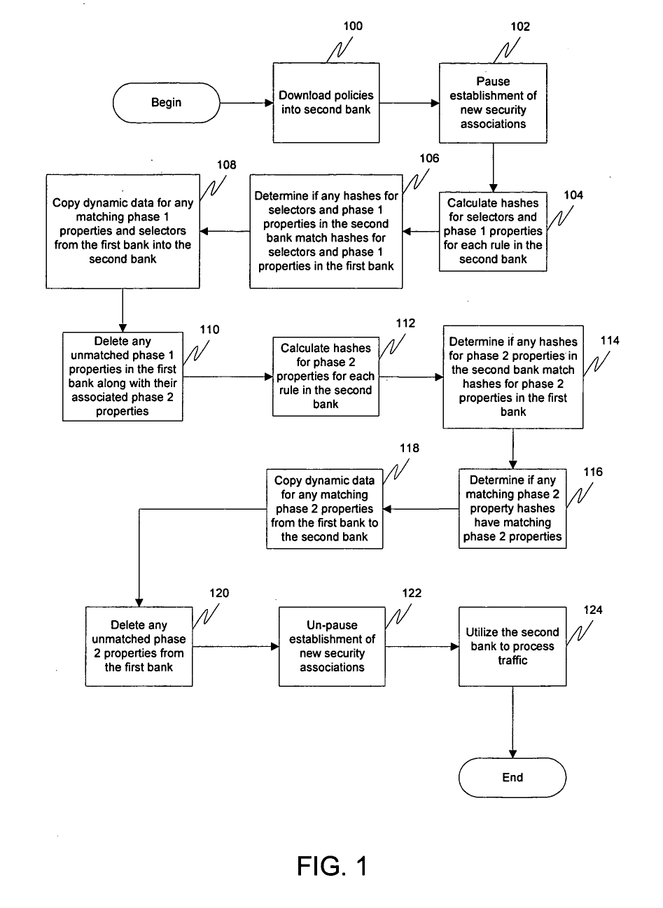

FIG. 1 is a flow diagram illustrating a method for applying a change or addition to a security policy in a computer network in accordance with an embodiment of the present invention. Each act of the method may be executed by hardware, software, or any combination thereof. The old bank and the new bank may be known as the first bank and the second bank, respectively. The security policy may be stored in a first bank. The changed or added security may include one or more phase 1 properties, one or more phase 2 properties, and one or more selectors. At 100, policies may be downloaded into a second bank. These policies may be a combination of new, updated, and old policies. In an embodiment of the present invention, selectors and phase 1 properties may be stored in a first table in the second bank, with phase 2 properties stored in a second table in the second bank. At 102, establishment of new security associations may be paused. At 104, hashes for selectors and phase 1 properties may be calculated for each rule in the second bank. At 106, it may be determined if any hashes for selectors and phase 1 properties in the second bank match hashes for selectors and phase 1 properties in the first bank. At 108, dynamic data for any matching phase 1 properties and selectors may be copied from the first bank into the second bank. This may be accomplished by setting a pointer to a security association data block corresponding to a matching phase 1 property in the second bank. At 110, any unmatched phase 1 properties in the first bank may be deleted with their associated phase 2 properties.

At 112, hashes may be calculated for phase 2 properties for each rule in the second bank. At 114, it may be determined if any hashes for phase 2 properties in the second bank match hashes for phase 2 properties in the first bank. If a matching hash is found, it is still possible that the phase 2 properties themselves do not match. Therefore, at 116, it may be determined if any matching phase 2 property hashes have matching phase 2 properties. At 118, dynamic data for any matching phase 2 properties may be copied from the first bank to the second bank. This may be accomplished by setting a pointer to a security association data block corresponding to a matching phase 2 property in the second bank. At 120, any unmatched phase 2 properties may be deleted from the first bank.

At 122, establishment of new security associations may be un-paused. Then, at 124, the second bank may be utilized to process traffic.

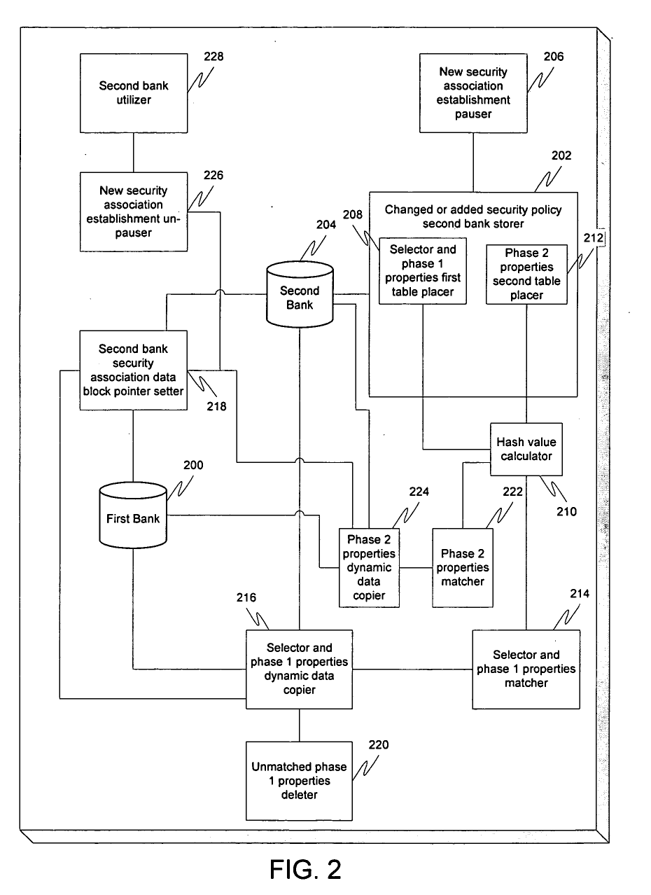

FIG. 2 is a block diagram illustrating an apparatus for applying a change or addition to a security policy in a computer network in accordance with an embodiment of the present invention. Each element of the apparatus may be located in hardware, software, or any combination thereof. The security policy may be stored in a first bank 200. The changed or added security may include one or more phase 1 properties, one or more phase 2 properties, and one or more selectors. A changed or added security policy second bank storer 202 coupled to a second bank 204 may store the changed or added security policy in the second bank 204. A new security association pauser 206 coupled to the changed or added security policy second bank storer 202 may pause establishment of new security associations.

The changed or added security policy second bank storer 202 may include a selector and phase 1 properties first table placer 208, which may place the selectors and phase 1 properties of the changed or added security policy in a first table in a second bank 204. The first table may be a hash table, and the storing may include calculating a hash value for the first table based on the sum of values of each of the selectors and phase 1 properties using a hash value calculator 210 coupled to the selector and phase 1 properties first table placer 208. The changed or added security policy second bank storer 204 may also include a phase 2 properties second table placer 212 coupled to the hash value calculator 210, which may place the phase 2 properties of the changed or added security policy in a second table in the second bank 204. The second table may also be a hash table, and the storing may include calculating a hash value for the second table based on the sum of values of each of the phase 2 properties using the hash value calculator 210.

The hash value calculator 210 may then calculate hashes for selectors and phase 1 properties for each rule in the second bank. Then, a selector and phase 1 properties matcher 214 coupled to the hash value calculator 210 may determine if any hashes for selectors and phase 1 properties in the second bank match hashes for selectors and phase 1 properties in the first bank. A selector and phase 1 properties dynamic data copier 216 coupled to the first bank 200, second bank 204, and to the selector and phase 1 properties matcher 214 may copy dynamic data for any matching phase 1 properties and selectors from the first bank into the second bank. This may be accomplished by setting a pointer to a security association data block corresponding to a matching phase 1 property in the second bank using a second bank security association data block pointer setter 218. Then, an unmatched phase 1 properties deleter 220 coupled to the selector phase 1 properties dynamic data copier 216 may delete any unmatched phase 1 properties in the first bank 200 along with their associated phase 2 properties.

The hash value calculator 210 may then calculate hashes for phase 2 properties for each rule in the second bank. If a matching hash is found, it is still possible that the phase 2 properties themselves do not match. Therefore, a phase 2 properties matcher 222 coupled to the hash value calculator may determine if any matching phase 2 property hashes have matching phase 2 properties. Dynamic data for any matching phase 2 properties may then be copied from the first bank to the second bank by a phase 2 properties dynamic data copier 224 coupled to the first bank 200, second bank 204, and to the phase 2 properties matcher 222. This may be accomplished by setting a pointer to a security association data block corresponding to a matching phase 2 property in the second bank using the second bank security association data block pointer setter 218. The selector and phase 1 properties dynamic data copier 216 and phase 2 properties dynamic data copier 224 may collectively be known as a dynamic data transferror (not pictured).

While it is not pictured, the selector and phase 1 properties matcher and the phase 2 properties matcher may collectively be known as a changed or added security policy matcher.

A new security association un-pauser 226 coupled to the phase 2 properties dynamic data copier 224 may un-pause establishment of new security associations. Then, a second bank utilizer 228 coupled to the new security association establishment un-pauser 226 may utilize the second bank 204 to process traffic.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method for applying a change or addition to a security policy in a computer network, the security policy stored in a first bank, the method comprising:
storing the changed or added security policy in a second bank;
pausing establishment of new security associations;
searching for an entry matching the changed or added security policy in the first bank;
transferring dynamic data in the first bank corresponding to said matching security policy to said second bank;
un-pausing establishment of new security associations; and
utilizing said second bank to process traffic flow.

2. The method of claim 1, wherein the changed or added security policy includes one or more phase 1 properties, one or more phase 2 properties, and one or more selectors.

3. The method of claim 2, wherein said storing further comprises:
placing said selectors and phase 1 properties in a first table in the second bank; and
placing said phase 2 properties in a second table in the second bank.

4. The method of claim 3, wherein said first and second tables are both hash tables.

5. The method of claim 4, wherein said placing said selectors and phase 1 properties includes calculating a hash value for said first table based on the sum of values of each of said selectors and phase 1 properties.

6. The method of claim 5, wherein said placing said phase 2 properties includes calculating a hash value for said second table based on the sum of values of each of said phase 2 properties.

7. The method of claim 1, wherein said searching includes searching the first bank for any phase 1 properties matching phase 1 properties in the changed or added security policy.

8. The method of claim 7, wherein said searching further includes searching the first bank for any phase 2 properties matching phase 2 properties in the changed or added security policy, said phase 2 properties in the first bank associated with a matching phase 1 property, if a matching phase 1 property is found in the first bank.

9. The method of claim 7, further comprising deleting any unmatched phase 1 properties in the first bank along with their associated phase 2 properties.

10. The method of claim 6, wherein said searching further includes searching the first bank for any phase 1 properties matching phase 1 properties in the changed or added security policy by comparing said hash value for said first table with hash values in a phase 1 table in the first bank.

11. The method of claim 10, wherein said searching further includes searching the first bank for any phase 2 properties matching phase 2 properties in the changed or added security policy, said phase 2 properties in the first bank associated with a matching phase 1 property, if a matching phase 1 property is found in the first bank, by comparing said hash value for said second table with hash values in a phase 2 table in the first bank.

12. The method of claim 7, wherein said transferring includes:
transferring dynamic data corresponding to matching phase 1 properties from the first bank to the second bank.

13. The method of claim 8, wherein said transferring includes:
transferring dynamic data corresponding to matching phase 2 properties from the first bank to the second bank.

14. The method of claim 1, wherein said transferring includes:
setting a pointer in the second bank to a security association data block associated with the first bank.

15. An apparatus for applying a change or addition to a security policy in a computer network, the apparatus comprising:
a first bank;
a second bank;
a new security association establishment pauser;
a changed or added security policy second bank storer coupled to said new security association establishment pauser and to said second bank;
a changed or added security policy matcher coupled to said first bank;
a dynamic data transferror coupled to said changed or added security policy matcher, said first bank, and said second bank;
a new security association establishment un-pauser coupled to said dynamic data transferror; and
a second bank utilizer coupled to said new security association establishment un-pauser.

16. The apparatus of claim 15, wherein said changed or added security policy second bank storer includes:
a selector and phase 1 properties first table placer; and
a phase 2 properties second table placer.

17. The apparatus of claim 16, further comprising a hash value calculator coupled to said selector and phase 1 properties first table placer and to said phase 2 properties second table placer.

18. The apparatus of claim 15, wherein said changed or added security policy matcher includes:
a selector and phase 1 properties matcher.

19. The apparatus of claim 18, wherein said changed or added security policy matcher further includes:
a phase 2 properties matcher coupled to said selector phase 1 properties matcher.

20. The apparatus of claim 19, wherein further including:
an unmatched selector and phase 1 properties deleter coupled to said selector and phase 1 properties matcher.

21. The apparatus of claim 15, wherein said dynamic data transferror includes a second bank security association data block pointer setter.

22. An apparatus for applying a change or addition to a security policy in a computer network, the security policy stored in a first bank, the apparatus comprising:
means for storing the changed or added security policy in a second bank;
means for pausing establishment of new security associations;
means for searching for an entry matching the changed or added security policy in the first bank;
means for transferring dynamic data in the first bank corresponding to said matching security policy to said second bank;
means for un-pausing establishment of new security associations; and
means for utilizing said second bank to process traffic flow.

23. The apparatus of claim 22, wherein the changed or added security policy includes one or more phase 1 properties, one or more phase 2 properties, and one or more selectors.

24. The apparatus of claim 23, wherein said storing further comprises:
means for placing said selectors and phase 1 properties in a first table in the second bank; and
means for placing said phase 2 properties in a second table in the second bank.

25. The apparatus of claim 24, wherein said first and second tables are both hash tables.

26. The apparatus of claim 25, wherein said means for placing said selectors and phase 1 properties includes means for calculating a hash value for said first table based on the sum of values of each of said selectors and phase 1 properties.

27. The apparatus of claim 26, wherein said means for placing said phase 2 properties includes means for calculating a hash value for said second table based on the sum of values of each of said phase 2 properties.

28. The apparatus of claim 22, wherein said means for searching includes means for searching the first bank for any phase 1 properties matching phase 1 properties in the changed or added security policy.

29. The apparatus of claim 28, wherein said means for searching further includes means for searching the first bank for any phase 2 properties matching phase 2 properties in the changed or added security policy, said phase 2 properties in the first bank associated with a matching phase 1 property, if a matching phase 1 property is found in the first bank.

30. The apparatus of claim 28, further comprising means for deleting any unmatched phase 1 properties in the first bank along with their associated phase 2 properties.

31. The apparatus of claim 27, wherein said means for searching further includes means for searching the first bank for any phase 1 properties matching phase 1 properties in the changed or added security policy by comparing said hash value for said first table with hash values in a phase 1 table in the first bank.

32. The apparatus of claim 31, wherein said means for searching further includes means for searching the first bank for any phase 2 properties matching phase 2 properties in the changed or added security policy, said phase 2 properties in the first bank associated with a matching phase 1 property, if a matching phase 1 property is found in the first bank, by comparing said hash value for said second table with hash values in a phase 2 table in the first bank.

33. The apparatus of claim 28, wherein said means for transferring includes:
means for transferring dynamic data corresponding to matching phase 1 properties from the first bank to the second bank.

34. The apparatus of claim 29, wherein said means for transferring includes:
means for transferring dynamic data corresponding to matching phase 2 properties from the first bank to the second bank.

35. The apparatus of claim 22, wherein said means for transferring includes:
means for setting a pointer in the second bank to a security association data block associated with the first bank.

36. A program storage device readable by a machine, tangibly embodying a program of instructions executable by the machine to perform a method for applying a change or addition to a security policy in a computer network, the security policy stored in a first bank, the method comprising:
storing the changed or added security policy in a second bank;
pausing establishment of new security associations;
searching for an entry matching the changed or added security policy in the first bank;
transferring dynamic data in the first bank corresponding to said matching security policy to said second bank;
un-pausing establishment of new security associations; and
utilizing said second bank to process traffic flow.
